(19) United States
(12) Patent Application Publication
(10) Pub. No.: US 2024/0416375 A1
(43) Pub. Date: Dec. 19, 2024

(54) METHOD FOR CONTROLLING THE CIRCULATION OF A FLUID IN A SPRAYING SYSTEM

(71) Applicant: EXEL INDUSTRIES, EPERNAY (FR)

(72) Inventors: Cyril DEBOISSIEU, BEAUJOLAIS (FR); David DIJOUX, SAINT JULIEN SUR VEYLE (FR)

(73) Assignee: EXEL INDUSTRIES, EPERNAY (FR)

(21) Appl. No.: 18/735,521

(22) Filed: Jun. 6, 2024

(30) Foreign Application Priority Data
Jun. 15, 2023 (FR) 2306142

(51) Int. Cl. B05B 12/08; B05B 1/20

(52) U.S. Cl. CPC B05B 12/085; B05B 1/20

(57) ABSTRACT

The present invention relates to a method for controlling the fluid circulation in a spraying system comprising a boom comprising a nozzle, supply means, at least one pulse-width modulation generator of a signal and a pressure sensor, said method comprising the following steps:
a) setting a reference pressure;
b) calculating a percentage of flow rate reduction to be applied according to said pressure, said percentage of flow rate reduction corresponding to the expected flow rate; then
c) generating a control signal corresponding to said expected flow rate;
d) spraying a liquid, by measuring the supply pressure of said nozzle;
e) measuring a flow rate of liquid supplying the boom;
f) determining the outgoing liquid flow rate of liquid leaving said nozzle
g) modifying the control of the generator according to a comparison between the determined outgoing liquid flow rate and the expected flow rate.

### TECHNICAL FIELD

The present invention relates to an automatic method for determining at least one modeling parameter of a fluid spraying system. Such a fluid may be used to treat soil or crops, for example as a fertilizer or a phytosanitary product.

### TECHNICAL BACKGROUND

In the field of the fluid spraying, and especially phytosanitary products in liquid form for soil or crop treatment, a spraying system comprising a spray boom is known to be on-boarded on a motorized vehicle, such as a tractor. The agricultural spray booms generally comprise nozzle holders distributed uniformly along the entire length of the spray boom, for spraying phytosanitary product in liquid form onto rows of plants by means of spray nozzles.

According to the manufacturer's specifications of this liquid, a certain dose must be applied per hectare, and the flow rate of the liquid to convey to the boom is calculated according to the boom's working width and the speed of the machine on which the spraying system is on-boarded. It is known to adapt the flow rate of product provided to the boom according to the speed of the machine, in order to obtain a dose per hectare that is as constant as possible.

The flow rate of phytosanitary product provided to the boom may be measured using a flowmeter, which takes a direct reading of the flow rate of liquid circulating in a duct supplying the boom. This type of measurement requires constant information on the number of nozzles of the boom actually used, which may vary during a spraying operation, particularly to take account of the actual geometry of the field being treated, this field being not necessarily rectangular and may not have a width that is a multiple of the total length of the boom.

It is known from the patent FR2995179 that the pressure of the phytosanitary product provided to the boom may, like the flow rate of said product, be adapted to the boom according to the machine speed, in order to obtain a controlled dose per hectare. The technologies used for pressure regulation are different from those used for flow rate regulation. The pressure regulation of the phytosanitary product provides a more precise spraying than a flowmeter regulation for low flow rates.

In addition, pulse-width modulation coils may be added to the spraying system to maintain a constant pressure of the liquid sprayed through the nozzles throughout the spraying operation, while allowing the modulation of the liquid flow rate. However, said pulse-width modulation coils generate a non-linearity between the pulse-width control and the liquid sprayed by the nozzles. Depending on the user's needs, the liquid sprayed may vary, as may the type of nozzles. Thus, the spray correction curve to compensate for this non-linearity of the flow rate may also vary according to the liquid sprayed or the type of nozzle. It is therefore not possible to know and adjust the spraying in real time, according to the specific use.

The invention aims to overcome the disadvantages of the prior art, in particular by proposing an automatic method for determining at least one modeling parameter of a system for spraying a liquid integrating a pulse-width modulation generator of a control signal allowing a spraying work at constant pressure but with a flow rate that may be modulated, in real time, according to a specific use.

### SUMMARY OF THE INVENTION

More specifically, the invention relates to a method for controlling the fluid circulation in a spraying system. In particular, said system comprises a spray boom comprising at least one spray nozzle, means for supplying said nozzle with liquid and at least one control unit configured to control the supply means according to a setpoint value of the supply pressure at which said at least one nozzle is supplied with liquid. Said spraying system comprises at least one pulse-width modulation generator of at least one control signal and at least one pressure sensor. Said method comprises the following steps:
a) setting a reference supply pressure of said at least one nozzle;
b) calculating a percentage of flow rate reduction to be applied according to said reference pressure by means of said control unit, said percentage of flow rate reduction corresponding to the expected flow rate; then
c) generating a control signal corresponding to said expected flow rate, by means of said control unit;
d) spraying a liquid, using the reference pressure as the setpoint supply pressure of said at least one nozzle and measuring the supply pressure of said at least one nozzle;
e) measuring by means of a flowmeter a flow rate of liquid supplying the boom;
f) determining the outgoing liquid flow rate of liquid leaving said at least one nozzle;
g) modifying the control of the pulse-width modulation generator according to a comparison between the determined outgoing liquid flow rate and the expected flow rate.

Advantageously, following the step e) and before the step f), the method comprises a step e′) of measuring a continuous circulation return flow rate by means of a further flowmeter, the step f) then being performed by the difference between the measured supply flow rate and the measured continuous circulation return flow rate.

The pulse-width modulation generator of a control signal allows a spraying at constant pressure and at modulated flow rate, in real time, as and when required.

In the case of a non-continuous fluid circulation in the spraying system, the flowmeter measures the flow rate of liquid supplying the spray boom. In this case, the determined outgoing liquid flow rate of liquid leaving the corresponding nozzle or nozzles corresponds to the flow rate measured by the flowmeter, i.e. to the flow rate of liquid supplying the boom, as there is no return to the tank.

The expected flow rate corresponds to a calculated flow rate, pre-registered and readjusted according to real-time data such as the speed, the dose per hectare, etc. The control of the pulse-width modulation generator is therefore modified according to the comparison between the flow rate measured by the flowmeter of the liquid supplying the spray boom and the calculated liquid flow rate. This calculated flow rate may vary according to various parameters, such as the forward speed of the agricultural machine.

In the case of a continuous fluid circulation in the spraying system, the flowmeter measures the flow rate of liquid supplying the spray boom, and the further flowmeter measures the flow rate of liquid of the continuous circulation return, i.e. the flow rate of the liquid that has not been sprayed by the spray nozzle or nozzles. The determined outgoing liquid flow rate of liquid leaving the nozzle or nozzles corresponds, in this case, to the difference between the flow rate measured by the first flowmeter (the one measuring the flow rate of liquid supplying the spray boom) and the flow rate measured by the further flowmeter (the one measuring the flow rate of liquid of the continuous circulation return). This determines, in real time, the flow rate of liquid sprayed by the spray nozzle or nozzles. The control of the pulse-width modulation generator is therefore modified according to the comparison between the flow rate of liquid supplying the spray boom measured by the first flowmeter and the liquid flow rate measured by the further continuous circulation return flowmeter.

Advantageously, the spray boom of the spraying system comprises a plurality of spray nozzles, and the outgoing liquid flow rate determined in the step f) is determined for the entire boom.

The plurality of spray nozzles allows an area to be covered that may be adapted to the user's needs. The nozzles of the plurality of nozzles are spaced apart so as to cover said area, but their spacing allows also to be adapted as required, for example by allowing a spacing corresponding to the spacing of the crop rows of the user to allow an in-row spraying or an inter-row spraying. The outgoing liquid flow rate is determined for the entire boom, i.e. the flow rate of liquid sprayed by the spray nozzles is determined in real time, whether the fluid is circulating in a continuous manner through the spraying system or in a non-continuous manner. The control of the pulse-width modulation generator is therefore modified according to the comparison between the flow rate measured by the first flowmeter of the liquid supplying the spray boom for the entire boom and the calculated liquid flow rate or the liquid flow rate measured by the further continuous circulation return flowmeter.

Advantageously, a pulse-width modulation generator of at least one control signal is associated with each of the nozzles of the plurality of spray nozzles.

This allows individual control of each nozzle.

Advantageously, the boom comprises at least two boom sections, each boom section comprising at least one spray nozzle, and the steps b), c), d), e), f) and g) are implemented section by section.

The section-by-section distribution allows a spraying to be adapted to the user's needs and/or to the liquid to be sprayed.

Advantageously, the steps a) to g) are repeated for several reference pressure values.

Advantageously, the method is implemented automatically by means of a computer.

The invention also relates to a spraying system on-boarded on a rolling machine for the implementation of a method as previously described. The spraying system comprises:
at least one tank of liquid to be sprayed;
at least one spray boom comprising at least one spray nozzle;
means for supplying the boom from said tank;
a pulse-width modulation generator of at least one control signal;
a sensor for measuring the pressure of the liquid in a duct supplying the boom;
a flowmeter configured to measure the flow rate of the treatment product supplying the boom;
a control unit configured to:
   determine the outgoing liquid flow rate of liquid leaving said at least one nozzle;
   determine a setpoint value (Pc) of the supply pressure at which the boom is supplied with liquid to be sprayed according, on the one hand, to a setpoint value of a flow rate of liquid to be sprayed and, on the other hand, to the determined outgoing liquid flow rate; and
control the means for supplying the boom according to the pressure setpoint value.

The spraying system of the invention allows the liquid to be sprayed according to the method described above.

Advantageously, the system further comprises a further continuous circulation return flowmeter, the control unit then determining the outgoing liquid flow rate of liquid leaving said at least one nozzle as the difference between the flow rate of liquid supplying the boom measured by the flowmeter and the continuous circulation return flow rate measured by the further flowmeter.

Advantageously, the spray boom comprises a plurality of spray nozzles, a pulse-width modulation generator of at least one control signal being associated with each of the nozzles of the plurality of spray nozzles.

### BRIEF DESCRIPTION OF THE DRAWINGS

The invention will be better understood on reading the following description, which is given by way of example only, with reference to the annexed drawings, which are given as non-limiting examples, wherein identical references are given to similar objects and wherein:

FIG. 1 is a schematic diagram of the spraying system according to a first embodiment of the invention;

FIG. 2 is a block diagram of the method for controlling the fluid circulation of the spraying system shown in FIG. 1;

FIG. 3 is a schematic diagram of the spraying system according to a second embodiment of the invention; and

FIG. 4 is a variant of the block diagram of the method for controlling the fluid circulation of the spraying system shown in FIG. 2.

It should be noted that the figures set out the invention in detail to allow the invention to be implemented; although non-limiting, said figures serve in particular to better define the invention where appropriate.

### DETAILED DESCRIPTION OF THE INVENTION

The invention relates to a method for controlling the fluid circulation in a spraying system 1.

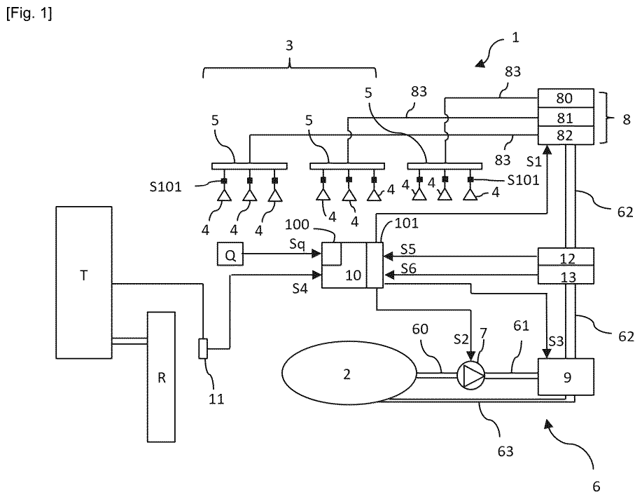

According to a first embodiment of the invention illustrated in FIG. 1, the spraying system 1 comprises at least one tank 2 for liquid to be sprayed, a spray boom 3 and means for supplying the spray boom 3 from the tank 2.

The spray boom 3 is configured to be carried or towed by a vehicle, in particular an agricultural machine, in this case an agricultural sprayer.

The boom 3 comprises a main duct 6 configured to convey the liquid supplied by the means for supplying the spray boom 3 from the tank 2 to at least one spray nozzle 4 connected to the spray boom 3.

As shown in FIG. 1, the spray boom 3 comprises a plurality of sections 5, in this case three sections 5, and a plurality of spray nozzles 4. The spray nozzles 4 are distributed over each of the sections 5.

In a first embodiment, as shown in FIG. 1, each section 5 of the spray boom 3 comprises the same number of spray nozzles 4, in this case three spray nozzles 4.

In a further embodiment not shown, the sections may comprise a different number of spray nozzles.

In particular, the main duct 6 connects the tank 2 to an assembly 8 of solenoid valves configured to control the liquid supply to the spray boom 3.

The main duct 6 comprises a first duct portion 60 which connects the tank 2 to a pump 7, for example a positive-displacement pump, a second duct portion 61 which connects the outlet of the pump 7 and a valve 9, which selectively supplies a third duct portion 62 of the main duct 6 or a duct 63 for returning the liquid to the tank 2. The valve 9 may be a three-way valve or a two-way valve.

The solenoid valve assembly 8 here comprises three solenoid valves-a first solenoid valve 80, a second solenoid valve 81 and a third solenoid valve 82-each controlling the circulation of the liquid from the main duct 6 towards one of the sections 5, through a pipe 83.

For example, the solenoid valves 80, 81, 82 may be poppet valves or any other type.

In a variant not shown, the solenoid valves of the solenoid valve assembly 8 configured to control the liquid supply to the spray boom 3 are replaced by a feeder which supplies the spray nozzles 4 directly.

The term “feeder” refers to a tubular device equipped with connections, allowing several circuits-in this case, several spray nozzles-to be supplied via each of its connections, from a central point.

The spraying system 1 also comprises a control unit 10 capable of controlling the solenoid valve assembly 8, the pump 7 and the valve 9.

In particular, the control unit 10 is configured to send a control signal S1 to the solenoid valve assembly 8, a control signal S2 to the pump 7 and a control signal S3 to the valve 9.

The control unit 10 comprises a memory 100 and a computer 101 configured to perform logic and arithmetic operations.

In this first embodiment, the spraying system 1 further comprises a pulse-width modulation generator of a control signal, a pressure sensor for measuring the pressure of the liquid in a duct supplying the boom 3 and a flowmeter 13.

The control unit 10 is capable of controlling the control of the pulse-width modulation generator.

The spraying system 1 is mounted on a machine such as an agricultural tractor T equipped with at least one wheel R.

The spraying system 1 comprises a rotation sensor 11 for measuring the rotation of the wheel R which transmits an electrical signal S4 representative of the rotation of the wheel R to the control unit 10. Knowing the dimensions of the wheel R, the control unit 10 may deduce the travel speed of the tractor T and the distance travelled from a point of origin.

Alternatively, the speed of displacement of the tractor T may be determined using a radar or a satellite positioning system (GPS), for example.

The spraying system 1 comprises a sensor 12 for measuring the pressure of the treatment liquid in the third duct portion 62 of the main duct 6.

The flowmeter 13 is configured to detect the flow rate of the treatment product or liquid in the main duct 6, supplying the spray boom 3.

The sensor 12 and the flowmeter 13 each transmit an electronic signal S5, respectively S6, to the control unit 10.

The signals S1 to S6 may be transmitted over power lines or by wireless communication means, such as radio.

The pulse-width modulation generator allows to maintain the pressure of the liquid circulating in the main duct 6, while allowing its flow rate to be modulated.

The control unit 10 allows to controls the pump 7 and the valve 9 according to a setpoint value of the supply pressure at which liquid treatment product is supplied to the solenoid valve assembly 8. However, the pump 7 may, for example, be operated manually by the user. In this way, the pump 7 may be started up and controlled by various means.

The pressure sensor 12 allows to provide to the control unit 10 a return signal, or feedback signal, since it delivers a signal representative of the pressure in the third duct portion 62 of the main duct 6, the pressure in this third duct portion 62 being considered equal to the supply pressure of the solenoid valve assembly 8.

The regulation used in the spraying system 1 is based on a model of the operation of each nozzle 4, where the flow rate in liters/minute is considered as proportional to the square root of the pressure in bars.

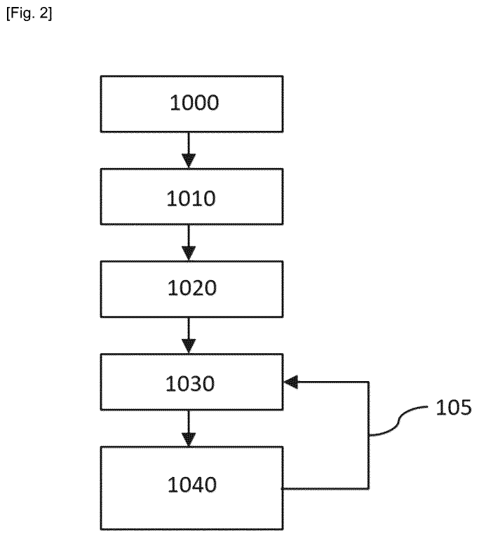

When the spraying system 1 is commissioned, the method shown in the block diagram in FIG. 2 is implemented.

In a first step 1000, a value is set for a reference supply pressure Pr of the nozzles 4.

In a second step 1010, the control unit 10 calculates a percentage of flow rate reduction to be applied according to the reference pressure Pr. The percentage of flow rate reduction corresponds to the expected flow rate.

The expected flow rate here corresponds to a calculated, pre-registered flow rate. This flow rate may be readjusted according to real-time data such as the speed, the dose per hectare, etc.

Then, said control unit 10 generates a control signal S1 towards each section 5 of spray boom 3, then, each pulse-width modulation generator associated with each spray nozzles 4 generates a control signal S101 with a chopping frequency corresponding to the expected flow rate.

Note that the control signal generated by each pulse-width modulation generator associated with each spray nozzles 4 may be different.

In a third step 1020, the spraying system 1 sprays liquid using the reference pressure Pr as the setpoint supply pressure Pc of the nozzles 4. In other words, the valve 9 is controlled to supply the nozzles 4 with a pressure Pr delivered to the assembly 8. It is assumed here that the pressure in the third duct portion 62 is equal or substantially equal to the supply pressure of the nozzles 4, as the pressure drops in the valves 80 to 82 and in the ducts 83 are taken into account in the prior calibration of the pressure sensor 12.

When the system 1 is operating at steady state, and the nozzles 4 are spraying liquid, the flowmeter 13 is used to measure the total effective flow rate of liquid in the main duct 6 of the boom 3. It provides a corresponding signal S6 to the control unit 10.

At the same time, throughout step 1020, the sensor 12 provides the control unit 10 with a signal S5 representative of the supply pressure of the nozzles 4. In steady-state operation, the value of the total measured pressure Pt transmitted by the signal S5 must be equal to the value of the setpoint pressure Pc, within the measurement tolerances.

In a fourth step 1030, the control unit 10 determines the outgoing liquid flow rate of liquid leaving the nozzles 4 as the liquid flow rate supplying the boom. This flow rate determination is performed on the basis of the signal S6.

At the end of this step and in step 1040, the flow rate of liquid sprayed by the nozzles 4 is therefore determined, taking into account the value of the reference pressure Pr set in step 1000, directly or through the pressure Pt, and for the assembly of the spray boom 3, assuming that the nozzles 4 all behave in the same way.

Based on the previously calculated value representing the flow rate of liquid sprayed by the nozzles, the control signal of the pulse-width modulation generator is modified according to the expected flow rate, which is the calculated flow rate. The modification of the control signal, i.e. its correction, is represented by the digital reference 105 in FIG. 2.

Note that the method shown in FIG. 2 may be carried out fully automatically, using a computer configured for this purpose, since the operator only needs to start step 1000 for the subsequent steps to take place automatically.

In addition, the selection of the reference pressure at step 1000 may take place automatically, on the basis of one or more values stored in the memory 100. In addition, the control and calculation steps of the invention method are performed by the computer 101, and the value or values of the flow rate calculated as a result of this method are stored in the memory 100, for later use.

In summary, this first embodiment corresponds to the case where the fluid circulation in the spraying system 1 is non-continuous. The flowmeter 13 measures the flow rate of liquid supplying the spray boom 3. The determined outgoing liquid flow rate of liquid leaving the spray nozzles 4 corresponds to the liquid flow rate measured by the flowmeter 13, i.e. the flow rate of liquid supplying the spray boom 3. The expected flow rate here corresponds to a calculated flow rate, pre-stored in the control unit 10. The flow rate measured by the flowmeter 13 is then compared with said calculated flow rate. The control of the pulse-width modulation generator is therefore modified according to this comparison between the flow rate measured by the flowmeter 13 of the liquid supplying the spray boom 3 and the calculated liquid flow rate.

The calculated flow rate may vary according to various parameters, such as the forward speed of the agricultural machine.

Alternatively, the flow rate of liquid sprayed by the nozzles 4 may be determined for each boom section 5. To do this, steps 1000 to 1040 are implemented boom section 5 after boom section 5, selectively opening and closing the solenoid valves 80, 81, 82.

This approach increases the accuracy of the determination of the flow rate of liquid sprayed by the nozzles 4 and, consequently, of the correction obtained by the unit 10 when it controls the valve 9 and the assembly 8, taking into account the feedback signal S5 delivered by the sensor 12.

A setpoint value for the liquid dose per hectare Q may be provided to the unit 10 in the form of an electronic signal Sq, and the computer 100 is able to determine, at any time during operation of the system 1, and according to the working width of the boom 3 and of the forward speed of the tractor T, an instantaneous setpoint flow rate of product to be sprayed.

Steps 1000, 1010, 1020, 1030, 1040 and 105 may also be implemented fully automatically in this variant.

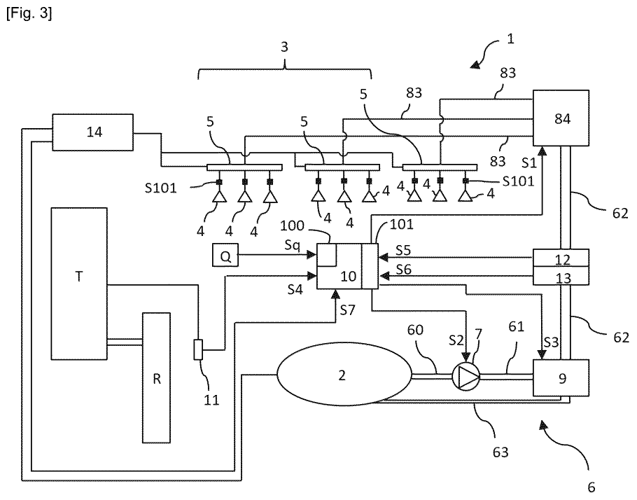

A second embodiment of the invention is shown in FIG. 3.

This second embodiment corresponds to the case of continuous fluid circulation in the spraying system 1.

The parts common to the first and second embodiments have the same numerical references.

This embodiment is similar to the first embodiment except that the main duct 6 connects the tank 2 to a feeder 84 configured to control the liquid supply to the spray boom 3, rather than an assembly of solenoid valves.

In this embodiment, the spraying system 1 also comprises a further flowmeter 14.

The flowmeter 14 is a continuous circulation return flowmeter configured to detect the flow rate of treatment product or liquid not sprayed by each boom section 5, and therefore by the spray boom 3.

The flowmeter 14 transmits an electronic signal S7 to the control unit 10.

The signal S7, like the signals S1 to S6, may be transmitted over power lines or by wireless communication means, such as radio.

When the spraying system 1 is commissioned, the method shown in the block diagram in FIG. 2 is also implemented.

In the first step 1000, a value is set for a reference supply pressure Pr of the nozzles 4.

In the second step 1010, the control unit 10 calculates a percentage of flow rate reduction to be applied according to the reference pressure Pr. The percentage of flow rate reduction corresponds to the expected flow rate.

Then, the control unit 10 may generate a control signal S1 towards each section 5 of the boom, and each pulse-width modulation generator associated with each spray nozzle 4 generates a control signal S101 with a chopping frequency corresponding to the expected flow rate.

In the third step 1020, the spraying system 1 sprays liquid using the reference pressure Pr as the setpoint supply pressure Pc of the nozzles 4. In other words, the valve 9 is controlled to supply the nozzles 4 with a pressure Pr delivered to the feeder 84. It is assumed here that the pressure in the third duct portion 62 is equal to or substantially equal to the supply pressure of the nozzles 4, the pressure drops in the feeder 84 and in the ducts 83 being taken into account in the prior calibration of the pressure sensor 12.

When the system 1 is operating at steady state, and the nozzles 4 are spraying liquid, the flowmeter 13 is used to measure the total effective flow rate of liquid in the main duct 6 of the boom 3. It provides a corresponding signal S6 to the control unit 10.

At the same time, throughout step 1020, the sensor 12 provides the control unit 10 with a signal S5 representative of the supply pressure of the nozzles 4. In steady-state operation, the value of the total measured pressure Pt transmitted by the signal S5 must be equal to the value of the setpoint pressure Pc, within the measurement tolerances.

In addition, the flowmeter 14 is used to measure the flow rate of return liquid in continuous circulation. It provides the electronic signal S7 to the control unit 10.

In step 1030, the control unit 10 determines the outgoing liquid flow rate of liquid leaving the nozzles 4 as the difference between the flow rate of liquid supplying the boom 3 and the continuous circulation return flow rate. This flow rate determination is performed on the basis of the signals S6 and S7.

At the end of this step and in step 1040, the flow rate of liquid sprayed by the nozzles 4 is therefore determined, taking into account the value of the reference pressure Pr set in step 1000, directly or through the pressure Pt, and for the assembly of the spray boom 3.

From the previously calculated value representative of the liquid flow rate sprayed by the nozzles, the control signal of the pulse-width modulation generator is modified according to the expected flow rate, which is the sprayed flow rate. The modification of the control signal, i.e. its correction, is represented by the digital reference 105 in FIG. 2.

Note that the method shown in FIG. 2 may be carried out fully automatically, using a computer configured for this purpose, since the operator only needs to start step 1000 for the subsequent steps to take place automatically.

In addition, the selection of the reference pressure at step 1000 may take place automatically, on the basis of one or more values stored in the memory 100. In addition, the control and calculation steps of the invention method are performed by the computer 101, and the value or values of the flow rate calculated as a result of this method are stored in the memory 100, for later use.

In summary, this second embodiment corresponds to the case of a continuous fluid circulation in the spraying system 1. The flowmeter 13 measures the flow rate of liquid supplying the spray boom 3, and the further flowmeter 14 measures the flow rate of liquid from the continuous circulation return, i.e. the flow rate of the liquid that has not been sprayed by the spray nozzles. The determined outgoing liquid flow rate of liquid leaving the nozzle 4 corresponds, in this case, to the difference between the flow rate measured by the first flowmeter 13 (that measuring the flow rate of liquid supplying the spray boom 3) and the flow rate measured by the further flowmeter 14 (that measuring the flow rate of liquid from the continuous circulation return). In this way, the flow rate of liquid sprayed by the spray nozzles 4 is determined in real time. The control of the pulse-width modulation generator is therefore modified according to the comparison between the flow rate measured by the first flowmeter 13 of the liquid supplying the spray boom 3 and the liquid flow rate measured by the further flowmeter 14 of the continuous circulation return.

In this way, the invention allows a spraying work to be carried out at constant pressure and with a flow rate that may be modulated, in real time, to suit a specific application. The difference between the two flow rate measurements, calculated either between a calculated flow rate and a boom supply flow rate, or between a flow rate measured by a first flowmeter 13 and a second flowmeter 14, allows the liquid sprayed by the nozzles 4 to be determined in real time. The expected sprayed liquid flow rate is then compared with the actual sprayed liquid flow rate, and the control of the modulation generator may be corrected to match the two flow rates. As a result, the spraying is adaptable to the type of liquid sprayed, the type of nozzle, the actual geometry of the field, etc.

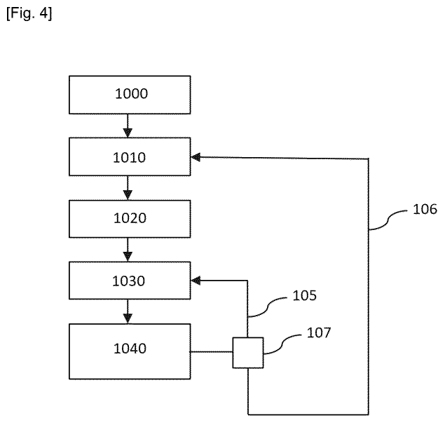

In addition, as shown in FIG. 4, the duty cycle may vary from 30% to 90% in both the first and second embodiments. The reference 107 illustrates the intermediate step wherein the value of the pulses is determined and compared with the 30% and 80% limit values. If the result of the calculation of the corrective of said control does not tend towards these limits, the control signal is modified, i.e. corrected (reference 105). If the result of the calculation of the corrective of said control tends towards these limits, the value of the setpoint pressure Pc is recalculated (reference 106) and the method returns to step 1010.

It should also be noted that the invention is not limited to the embodiments described above. Indeed, it will become apparent to the person skilled in the art that various modifications may be made to the above-described embodiment, in the light of the teachings just disclosed.

In the detailed presentation of the invention given above, the terms used should not be interpreted as limiting the invention to the embodiment set out in the present description, but should be construed to comprise all equivalents the anticipation of which is within the grasp of the person skilled in the art by applying his general knowledge to the implementation of the teaching just disclosed to him.

1. A method for controlling the fluid circulation in a spraying system, said system comprising a spray boom comprising at least one spray nozzle, means for supplying said nozzle with liquid and at least one control unit configured to control the supply means according to a setpoint value of the supply pressure at which said at least one nozzle is supplied with liquid, said spraying system comprising at least one pulse-width modulation generator of at least one control signal and at least one pressure sensor, said method comprising the following steps:
a) setting a reference supply pressure of said at least one nozzle;
b) calculating a percentage of flow rate reduction to be applied according to said reference pressure by means of said control unit, said percentage of flow rate reduction corresponding to the expected flow rate; then
c) generating a control signal corresponding to said expected flow rate, by means of said control unit;
d) spraying a liquid, using the reference pressure as the setpoint supply pressure of said at least one nozzle and measuring the supply pressure of said at least one nozzle;
e) measuring by means of a flowmeter a flow rate of liquid supplying the boom;
f) determining the outgoing liquid flow rate of liquid leaving said at least one nozzle;
g) modifying the control of the pulse-width modulation generator according to a comparison between the determined outgoing liquid flow rate and the expected flow rate.

2. The method according to claim 1, comprising, following the step e) and before the step f), a step e′) of measuring a continuous circulation return flow rate by means of a further flowmeter, the step f) then being performed by the difference between the measured supply flow rate and the measured continuous circulation return flow rate.

3. The method according to claim 1, wherein the spray boom of the spraying system comprises a plurality of spray nozzles and the outgoing liquid flow rate determined in the step f) is determined for the entire boom.

4. The method according to claim 3, wherein a pulse-width modulation generator of at least one control signal is associated with each of the nozzles of the plurality of spray nozzles.

5. The method according to claim 1, wherein the boom comprises at least two boom sections, each boom section comprising at least one spray nozzle, and wherein the steps b), c), d), e), f) and g) are implemented section by section.

6. The method according to claim 5, wherein the steps a) to g) are repeated for several reference pressure values.

7. The method according to claim 1, wherein said method is implemented automatically by means of a computer.

8. A spraying system on-boarded on a rolling machine for the implementation of a method according to claim 1, said spraying system comprising:
at least one tank of liquid to be sprayed;
at least one spray boom comprising at least one spray nozzle;
means for supplying the boom from said tank;
a pulse-width modulation generator of at least one control signal;
a sensor for measuring the pressure of the liquid in a duct supplying the boom;
a flowmeter configured to measure the flow rate of the treatment product supplying the boom;
a control unit configured to:
determine the outgoing liquid flow rate of liquid leaving said at least one nozzle;
determine a setpoint value of the supply pressure at which the boom is supplied with liquid to be sprayed according, on the one hand, to a setpoint value of a flow rate of liquid to be sprayed and, on the other hand, to the determined outgoing liquid flow rate; and
control the means for supplying the boom according to the pressure setpoint value.

9. The spraying system according to claim 8, further comprising a further continuous circulation return flowmeter, the control unit then determining the outgoing liquid flow rate of liquid leaving said at least one nozzle as the difference between the flow rate of liquid supplying the boom measured by the flowmeter and the continuous circulation return flow rate measured by the further flowmeter.

10. The spraying system according to claim 8, wherein the spray boom comprises a plurality of spray nozzles, a pulse-width modulation generator of at least one control signal being associated with each of the nozzles of the plurality of spray nozzles.
